(19) United States
(12) Patent Application Publication
(10) Pub. No.: US 2026/0183880 A1
(43) Pub. Date: Jul. 2, 2026

(54) SWING-TYPE TOOL MAGAZINE SYSTEM

(71) Applicants: HAO-CHUNG LEE, TAICHUNG CITY (TW); CHEN SOUND INDUSTRIAL CO., LTD., TAICHUNG CITY (TW)

(72) Inventors: HAO-CHUNG LEE, TAICHUNG CITY (TW); HO-HSUN TSAI, TAICHUNG CITY (TW)

(21) Appl. No.: 19/428,551

(22) Filed: Dec. 22, 2025

(30) Foreign Application Priority Data
Dec. 30, 2024 (TW) 113151404

(51) Int. Cl. B23Q 3/155

(52) U.S. Cl. CPC B23Q 3/15526; B23Q 3/1554

(57) ABSTRACT

A swing-type tool magazine system, which is disposed on a machine tool, includes a tool storage device in a tool storage area and a tool changing device in the tool changing area. The tool storage device has at least a tool placement assembly swingably connected to the reversing module, and a reversing module driving the tool placement assembly to swing along an XY plane between a first and a second positions. At the second position, the tool changing device drives the tool placement assembly to move along an X-axis, switching the tool placement assembly between the second position and a tool changing position, allowing the spindle to remove or return a tool. A rotation device is further included to drive a bracket of the tool placement assembly to rotate, aligning the tool with the tool changing direction of the spindle, achieving a multi-directional tool changing function.

### BACKGROUND OF THE DISCLOSURE

### 1. Field of the Disclosure

The present disclosure relates to tool magazine systems, and more particularly, to a swing-type tool magazine system.

### 2. Description of the Related Art

In order to improve machining efficiency, a machine tool is equipped with a tool magazine, such as a carousel-type tool magazine, chain-type tool magazine, or disc-type tool magazine, which is used together with a tool arm to enhance operational efficiency.

However, through practical experience by relevant technical personnel, it is known that conventional tool magazines have following technical issues.

The conventional tool magazines are unable to perform multi-directional tool changing operation. Commercially available tool magazines generally perform tool changing operation in a single direction. For example, when the spindle holds a side head or when the tool changing direction of the spindle differs from that of the tool, the multi-directional tool changing operation is unachievable within the same tool magazine, or a complex structure is required for changing the operational direction.

The conventional tool magazines have a small tool magazine capacity and only accommodate a single-specification tool shank. Commercially available tool magazines are capable of storing only a limited number of tools, and a single tool magazine is unable to accommodate tools with different shank specifications. For example, when the taper hole specification of the tool shank held by the side head differs from the taper hole specification of the spindle, the versatility is limited.

The conventional tool magazines have a space-occupying issue. Structures of commercially available tool magazines are complex, making it difficult to effectively reduce the tool magazine volume and consequently increasing the overall volume of the machine tool.

Accordingly, technical personnel in the field of the present disclosure are actively developing a technical solution to address the aforementioned issues, so as to improve the deficiencies of the prior arts.

### SUMMARY OF THE DISCLOSURE

The present disclosure aims at providing a multi-direction tool magazine system, which allows the installation of the same or different specifications of tool holders and tools on the tool holder seat according to machining requirements. The present disclosure also allows the installation of spindle heads or side heads of the same or different specifications as needed, thereby enhancing the work efficiency and versatility of the machine tool, so as to suitable for applications involving multi-spindle machine tools with multiple tools.

The aforementioned objectives do not prevent the existence of other objectives. Those objectives derivable from the specification, claims, or drawings of the present disclosure by a person having ordinary skill in the field of the disclosure are also included in the scope of objectives of the present disclosure. Therefore, the objectives of the present disclosure are not limited to the aforementioned objectives.

For achieving the aforementioned objectives, the present disclosure provides a swing-type tool magazine system, disposed on a machine tool having at least a spindle, a worktable, a tool storage area, and a tool changing area, the spindle can be in vertical orientation, a horizontal orientation, or a mixed arrangement of vertical and horizontal orientations the swing-type tool magazine system comprising:
a tool storage device disposed in the tool storage area, the tool storage device having at least a tool placement assembly and a reversing module, the tool placement assembly being swingably connected to the reversing module, the reversing module being configured to drive the tool placement assembly to swing along an XY plane, thereby switching the tool placement assembly between a first position in the tool storage area and a second position in the tool changing area; and
a tool changing device disposed in the tool changing area, wherein, when the tool placement assembly is at the second position, the tool changing device drives the tool placement assembly to move along an X-axis, switching the tool placement assembly between the second position and a tool changing position in the tool changing area, thereby allowing the spindle to remove or return a tool from or to the tool placement assembly;
the rotation device being arranged at a side of the tool changing area and configured to drive a bracket of the tool placement assembly to rotate, thereby aligning the tool with the spindle for tool changing operation, so as to achieve a multi-directional tool changing function.

In an embodiment of the present disclosure, the tool placement assembly comprises a reversing gear, a bracket, and a tool holder seat. A first end of the bracket is connected to the reversing gear. The tool holder seat is slidably disposed on the bracket. The reversing module comprises a first power unit and a driving gear. The driving gear is power-coupled to the first power unit, and the driving gear is movably engaged with the reversing gear, such that the bracket swings along the XY plane to switch between the first position and the second position.

In an embodiment of the present disclosure, the tool storage device comprises a plurality of tool placement assemblies stacked along a Z-axis. The plurality of tool placement assemblies are configured to be vertically movable along the Z-axis, and selectively position one of reversing gears at the first position, while other reversing gears are positioned at a standby position in the tool storage area. When one of reversing gears is positioned at the first position, the reversing gear at the first position engages with the driving gear, allowing the bracket at the first position to swing between the first position and the second position.

In an embodiment of the present disclosure, the tool storage device comprises a vertical movement module. The vertical movement module comprises a second power unit, a vertical movement seat, and a vertical movement rod. The vertical movement seat is connected to the second power unit. The vertical movement rod is disposed on the vertical movement seat along the Z-axis. The reversing gears of the tool placement assemblies are disposed on the vertical movement rod and spaced along the Z-axis.

In an embodiment of the present disclosure, each of the plurality of tool placement assemblies comprises a guide rail. The plurality of guide rails are connected to a plurality of the tool holder seats, such that the plurality of tool holder seats are slidable on a plurality of brackets. The tool changing device comprises a pushing module and a lifting and lowering module. When one of the brackets is at the second position, the lifting and lowering module moves the pushing module downward into the tool changing area, and the pushing module pushes the tool holder seat at the second position, such that the guide rail slides on the bracket, whereby the tool holder seat switches between the second position and the tool changing position along the X-axis.

In an embodiment of the present disclosure, each of the plurality of tool holder seats comprises a first engagement portion, and the pushing module comprises a second engagement portion. When one of the tool holder seats moves into the tool changing area, the lifting and lowering module moves the pushing module downward into the tool changing area, such that the first engagement portion and the second engagement portion engage with each other to push the tool holder seat at the second position.

In an embodiment of the present disclosure, the tool holder seat is configured to accommodate tool holders and tools of same or different specifications as required. In an embodiment, the present disclosure is configured to accommodate spindle heads and side heads of same or different specifications as required.

In an embodiment of the present disclosure, the present disclosure comprises a rotation device. The rotation device is disposed on a side of the tool changing area. The rotation device comprises a limiting module. When the bracket is at the second position, the bracket is in contact with the limiting module.

In an embodiment of the present disclosure, the bracket comprises a second end and a shaft. The second end is arranged on an end of the bracket opposite to the first end. The shaft is arranged adjacent to the first end, and the bracket is rotatable about the shaft.

In an embodiment of the present disclosure, when the second end of the bracket is in contact with the limiting module, the rotation device drives the second end of the bracket to rotate about the shaft, thereby rotating the tool together with the bracket to be aligned with a tool changing direction of the spindle.

Accordingly, the present disclosure achieves following technical features.

The present disclosure features high efficiency. The tool storage device simply needs to swing along the XY plane, thereby moving the tool to the tool changing area for the spindle to replace the tool, so as to enhance the efficiency of tool replacement operation.

The present disclosure features large capacity and accommodate various tool specifications. The tool storage device is capable of storing multiple sets of tools simultaneously in a longitudinal or lateral direction, and the tool holder seats are configured to accommodate tool holders and tools, and/or spindle heads or side heads of the same or different specifications as needed, thereby facilitating replacement of tools by the spindle.

The present disclosure features a space-saving function. Since the tool storage device and the tool changing device of the present disclosure directly perform the tool changing operation directly above the worktable, the overall volume of the machine tool is significantly reduced.

The present disclosure features different working modes. When the spindle holds a side head or when the tool changing direction of the spindle differs from that of the tool, the rotation device allows the bracket to rotate about its shaft, thereby rotating the tool together to align with the tool changing direction of the spindle. Also, when the tool placement assembly is in a vertical orientation, the spindle removes or returns the tools more easily, and the structure is simpler. When the tool placement assembly is in a horizontal orientation, the spacing between the tool placement assemblies can be arranged closer, thereby increasing the number of tool placement assemblies and the number of tools accommodated.

### BRIEF DESCRIPTION OF THE DRAWINGS

FIG. 1 is a perspective view of the swing-type tool magazine system in accordance with an embodiment of the present disclosure, illustrating the appearance features of the swing-type tool magazine system.

FIG. 2 is a side view of the swing-type tool magazine system in accordance with an embodiment of the present disclosure, illustrating a lateral side of the swing-type tool magazine system.

FIG. 3 is a schematic view of the swing-type tool magazine system in accordance with an embodiment of the present disclosure, illustrating the tool placement assembly swinging along the XY plane.

FIG. 4 is a side view of the tool storage device in accordance with an embodiment of the present disclosure, illustrating the appearance features of the tool storage device.

FIG. 5 is a schematic view of the tool storage device, illustrating the tool storage device moving upward along the Z-axis.

FIG. 6 is a schematic view of the tool changing device in accordance with an embodiment of the present disclosure, illustrating the pushing module pushing the tool holder seat along the X-axis.

FIG. 7 is another schematic view of the tool changing device in accordance with an embodiment of the present disclosure, illustrating the pushing module moving to the tool changing area.

FIG. 8 is a schematic view and partially enlarged view of the limiting module in accordance with an embodiment of the present disclosure, illustrating the second end of the bracket being in contact with the limiting module.

FIG. 9 is a perspective view of a dual-use tool magazine system operable in vertical and horizontal orientations in accordance with another embodiment of the present disclosure, illustrating the tool arranged in the horizontal state.

FIG. 10 is a schematic view and partially enlarged view of the limiting module in accordance with another embodiment of the present disclosure, illustrating the rotation device driving the movement of the second end of the bracket.

### DETAILED DESCRIPTION OF THE DISCLOSURE

The aforementioned and further advantages and features of the present disclosure will be understood by reference to the description of the preferred embodiment in conjunction with the accompanying drawings where the components are illustrated based on a proportion for explanation but not subject to the actual component proportion.

Embodiments of the present disclosure are illustrated in detail along with the drawings. However, the technical features included by the present disclosure are not limited to certain embodiments hereby provided. Scope of the present disclosure shall be referred to the claims, which include all the possible replacements, modifications, and equivalent features.

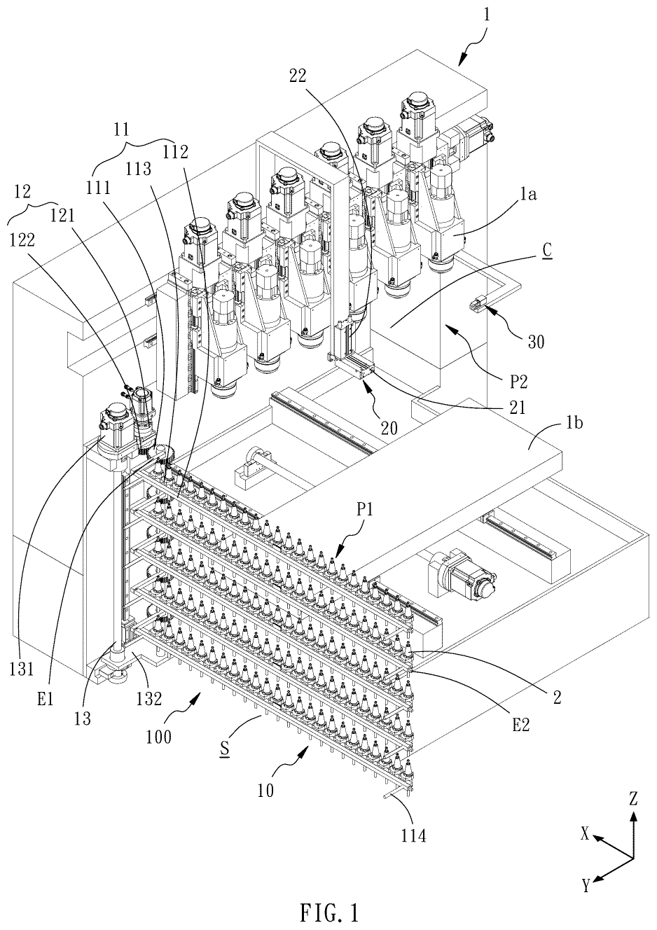

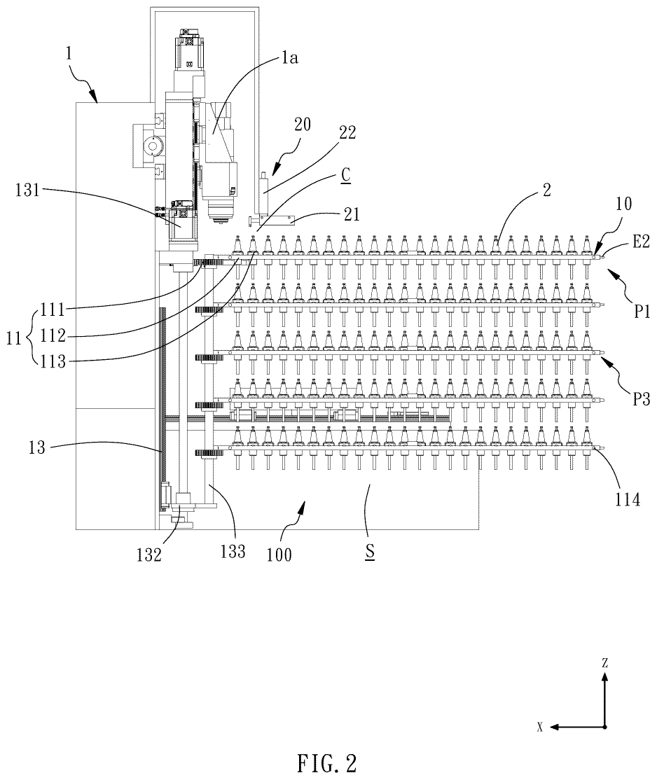

Referring to FIG. 1 to FIG. 10, in the embodiment, the present disclosure provides a swing-type tool magazine system 100, which is disposed on a machine tool 1 and used for a tool 2 replacement operation of the machine tool 1.

Referring to FIG. 1, the machine tool 1 comprises at least a spindle 1a, a worktable 1b, a tool storage area S, and a tool changing area C. The number of the spindle 1a is allowed to be one or plural. The tool storage area S and the tool changing area C are arranged adjacent to each other. The spindle 1a is disposed in the tool changing area C for performing a tool changing operation. In the embodiment, the spindle 1a is slidable along a Y-axis, and an axis 112a is arranged to be parallel to a Z-axis.

The swing-type tool magazine system 100 comprises a tool storage device 10 and a tool changing device 20.

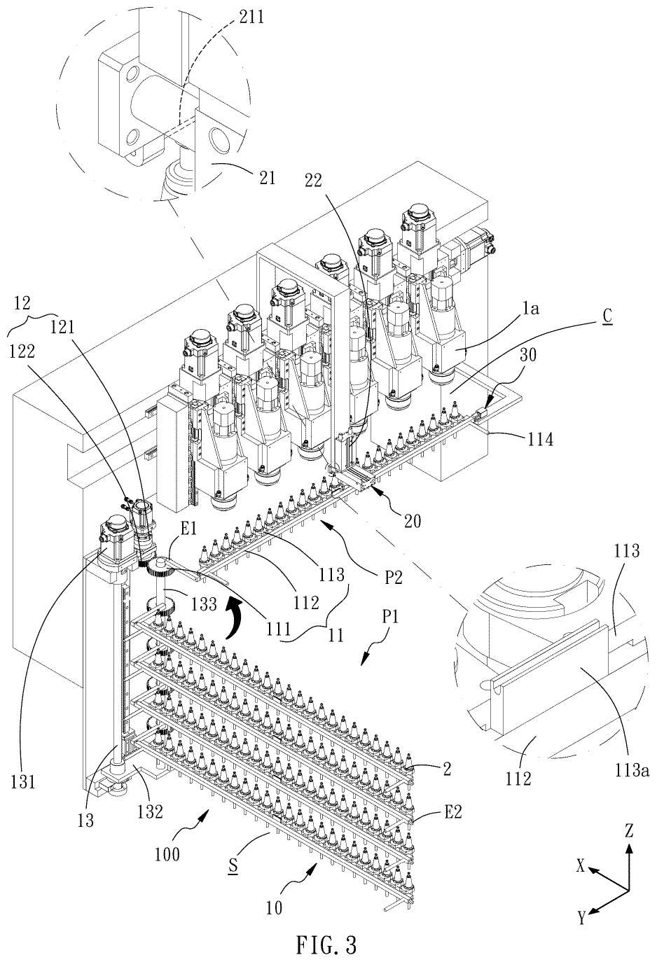

Referring to FIG. 1 to FIG. 3, the tool storage device 10 is arranged in the tool storage area S. The tool storage device 10 comprises at least a tool placement assembly 11 and a reversing module 12. The tool placement assembly 11 is swingably connected to the reversing module 12, and the tool placement assembly 11 is configured to store a plurality of tools 2. As shown in FIG. 3, the reversing module 12 is configured to drive the tool placement assembly 11 to swing along an XY plane, such that the tool placement assembly 11 is switchable between a first position P1 in the tool storage area S and a second position P2 in the tool changing area C. Since the first position P1 and the second position P2 are substantially arranged in an L-shaped configuration, a working space is thereby formed to facilitate operation of the machine tool 1.

The swing-type tool magazine system 100 further comprises a rotation device 30, which is disposed on a side of the tool changing area C. The rotation device 30 is configured to rotate a bracket 112 of the tool placement assembly 11, so as to align the tool 2 with a tool changing direction of the spindle 1a, thereby achieving a multi-directional tool changing function.

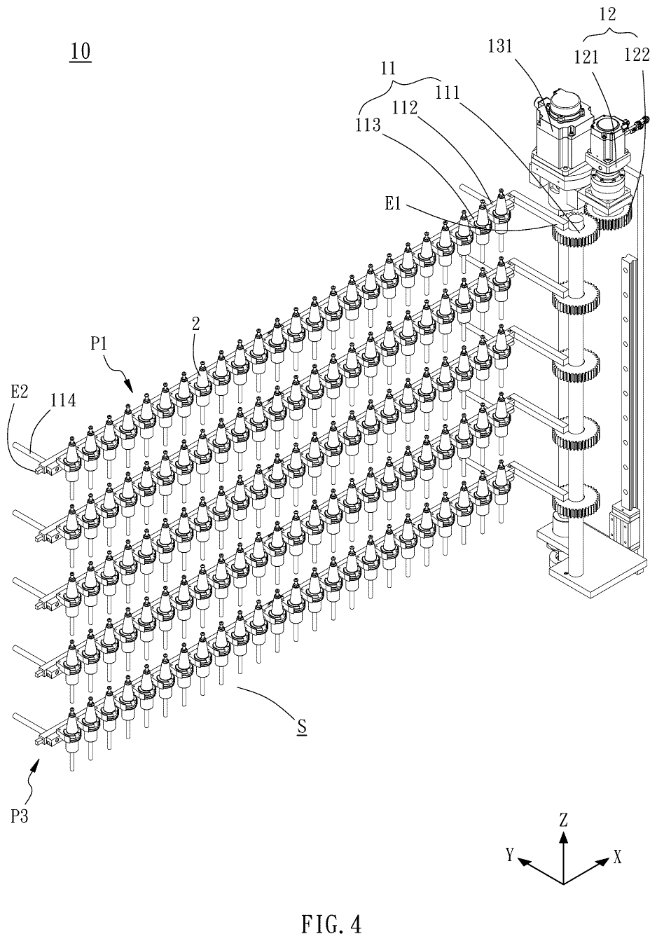

Referring to FIG. 4. in an embodiment, each tool placement assembly 11 comprises a reversing gear 111, a bracket 112, and a tool holder seat 113. A first end E1 of the bracket 112 is connected to the reversing gear 111. The tool holder seat 113 is slidably disposed on the bracket 112, such that the tool holder seat 113 is slidable on the bracket 112.

Referring to FIG. 4. the reversing module 12 comprises a first power unit 121 and a driving gear 122. In the embodiment, the first power unit 121 is allowed to be a motor. The driving gear 122 is power-connected to the first power unit 121, and the first power unit 121 is configured to drive the driving gear 122 to rotate clockwise or counterclockwise. Also, the driving gear 122 is movably engaged with the reversing gear 111. In other words, the driving gear 122 is selectively engaged with or disengaged from the reversing gear 111. Based on the foregoing technical features, the bracket 112 is capable of swinging along the XY plane to switch between the first position P1 and the second position P2, thereby transporting or storing the tool 2.

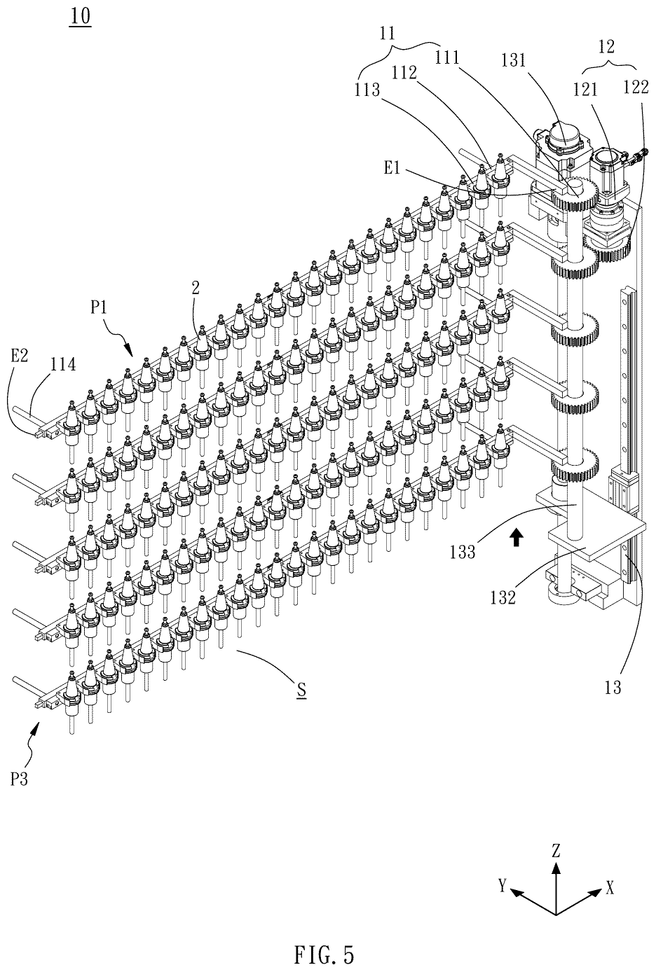

Referring to FIG. 4, in order to increase the number of stored tools 2, the tool storage device 10 is provided with a plurality of tool placement assemblies 11 stacked along a Z-axis direction. Referring to FIG. 5, the plurality of tool placement assemblies 11 are vertically movable upward and downward along the Z-axis, with one of the reversing gears 111 being selectively positioned at the first position P1, while the other reversing gears 111 being positioned at a standby position P3 in the tool storage area S. The standby position P3 is allowed to be arranged above or below the first position P1. When one of the reversing gears 111 is positioned at the first position P1, the reversing gear 111 positioned at the first position P1 engages with the driving gear 122, and the first power unit 121 drives the driving gear 122 and the reversing gear 111 to rotate, such that the bracket 112 at the first position P1 is capable of swinging to switch between the first position P1 and the second position P2.

In an embodiment, the tool storage device 10 comprises a vertical movement module 13. The vertical movement module 13 comprises a second power unit 131, a vertical movement seat 132, and a vertical movement rod 133. In the embodiment, the second power unit 131 is allowed to be a combination of a motor, a threaded rod, and a linear guide. The vertical movement seat 132 is connected to the second power unit 131, and the second power unit 131 is configured to drive the vertical movement seat 132 to move upward and downward along the Z-axis, so as to move the plurality of tool placement assemblies 11. The vertical movement rod 133 is disposed on the vertical movement seat 132 along the Z-axis direction, and the vertical movement rod 133 moves upward and downward along with movement of the vertical movement seat 132. The reversing gears 111 of the tool placement assemblies 11 are disposed on the vertical movement rod 133 and spaced along the Z-axis. Further, the vertical movement rod 133 passes through the plurality of reversing gears 111, such that the plurality of reversing gears 111 are mounted around the vertical movement rod 133 in series, and each reversing gear 111 is arranged in a transverse orientation, so as to be movably engaged with the driving gear 122.

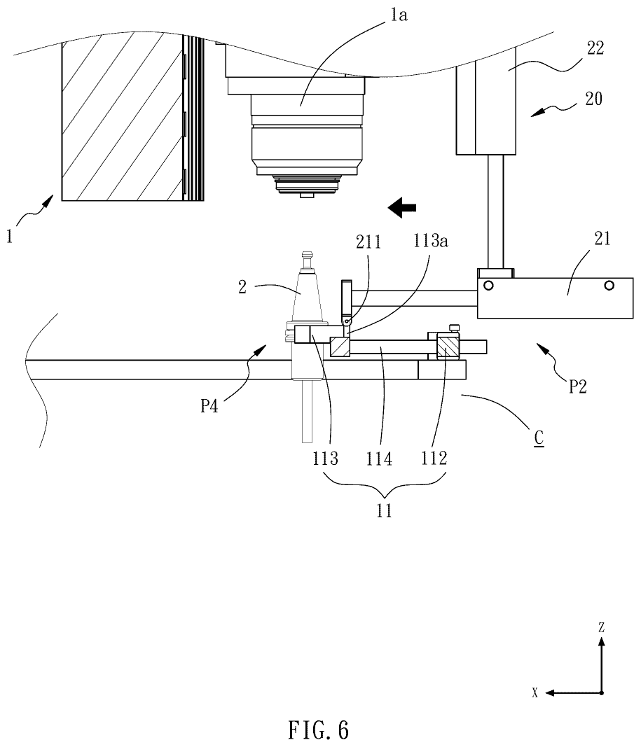

The tool changing device 20 is disposed in the tool changing area C. Referring to FIG. 6, when the tool placement assembly 11 is at the second position P2, the tool changing device 20 is configured to drive the tool placement assembly 11 to move along the X-axis direction to switch between the second position P2 and a tool changing position P4 in the tool changing area C, thereby allowing the spindle 1a to remove or return the tool 2 from or to the tool placement assembly 11.

During a tool removing operation, the tool holder seat 113 holds the tool 2, and the tool changing device 20 drives the tool holder seat 113 to move from the second position P2 to the tool changing position P4 along the X-axis. When the tool holder seat 113 is at the tool changing position P4, the spindle 1a moves downward along the Z-axis to the tool changing position P4 to grasp the tool 2. After the spindle 1a grasps the tool 2, the spindle 1a then moves upward to return to its original position, and the tool holder seat 113 retreats to the second position P2, so as to complete the tool removing operation.

During a tool returning operation, the spindle 1a moves along the Y-axis to a tool returning position where the tool holder seat 113 is not holding the tool 2, and then moves downward along the Z-axis direction to the tool changing position P4. The tool changing device 20 drives the tool holder seat 113 to move from the second position P2 to the tool changing position P4 along the X-axis, and then causes the tool holder on the tool holder seat 113 to clamp the tool 2. Afterward, the spindle 1a releases the tool and then moves upward along the Z-axis to its original position, and tool holder seat 113 retreats back to the second position P2, thereby completing the tool returning operation.

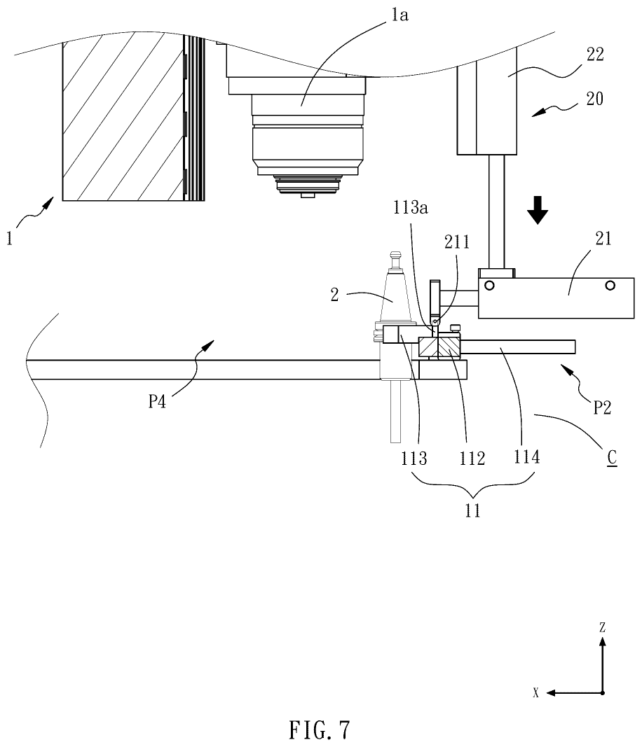

In an embodiment, each of the plurality of tool placement assemblies 11 has a guide rail 114. The plurality of guide rails 114 are connected to the plurality of tool holder seats 113, and allow the plurality of tool holder seats 113 to slide on the plurality of brackets 112. In the embodiment, two guide rails 114 are provided as a set, and the two guide rails are connected to two sides of each tool holder seat 113. Referring to FIG. 6 and FIG. 7, the tool changing device 20 comprises a pushing module 21 and a lifting and lowering module 22. When one of the brackets 112 is at the second position P2, the lifting and lowering module 22 moves the pushing module 21 downward to the tool changing area C. At this time, the pushing module 21 is configured to push the tool holder seat 113 at the second position P2, such that the guide rails 114 slide on the bracket 112, thereby causing the tool holder seat 113 to move along the X-axis direction to switch between the second position P2 and the tool changing position P4.

Referring to FIG. 3, each of the plurality of tool holder seats 113 has a first engagement portion 113a. The pushing module 21 comprises a second engagement portion 211. When the lifting and lowering module 22 moves the pushing module 21 downward to the tool changing area C, the first engagement portion 113a and the second engagement portion 211 are engaged with each other, and the pushing module 21 then pushes the tool holder seat 113 at the second position P2. Further, the top portion of each first engagement portion 113a has a recess, and the bottom portion of the second engagement portion 211 has a protrusion, wherein the shape of the recess corresponds to the shape of the protrusion, so that they are engaged with each other.

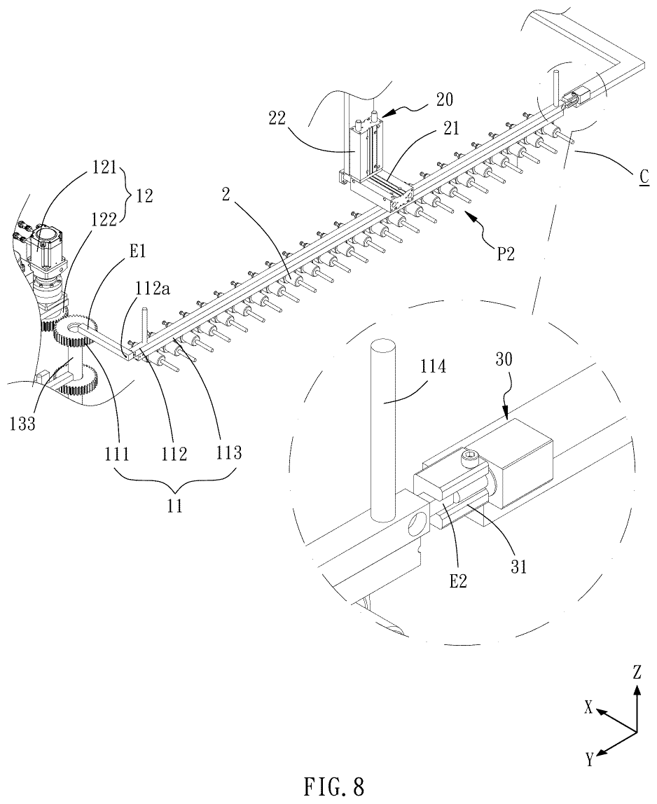

Referring to FIG. 8, in order to fix the tool placement assembly 11 which is arranged at the second position P2, the rotation device 30 of the swing-type tool magazine system 100 further comprises a limiting module 31. The limiting module 31 is disposed on a side of the tool changing area C. The limiting module 31 has a height equal to the height of the tool placement assembly 11 at the second position P2. When the bracket 112 is at the second position P2, the bracket 112 is in contact with the limiting module 31, so as to ensure the position of the tool placement assembly 11.

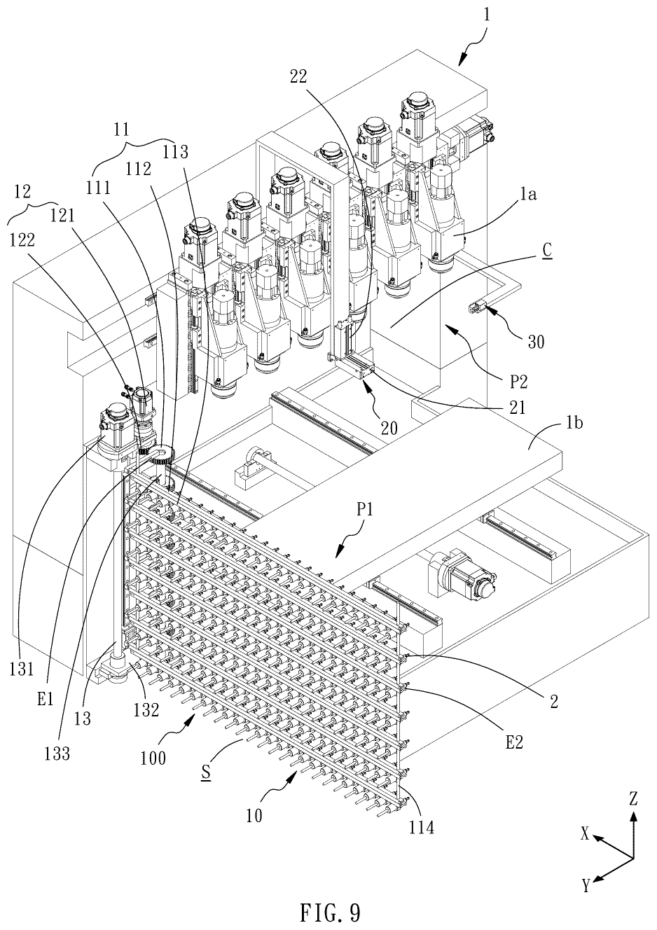

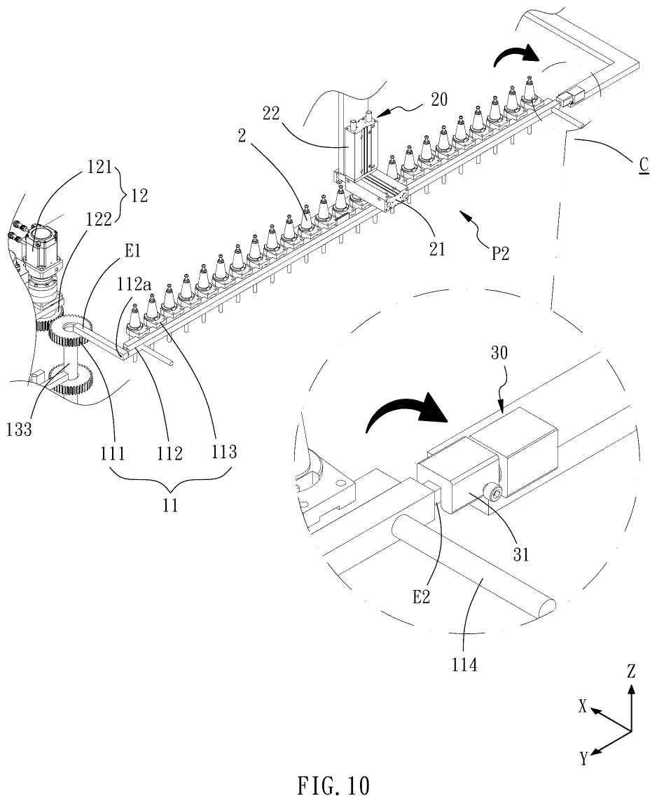

Referring to FIG. 9, in the embodiment, the tools 2 are arranged in a horizontal orientation. Referring to FIG. 8 and FIG. 10, in order to accommodate the tool 2 in the horizontal posture, the bracket 112 comprises as econd end E2 and a shaft 112a. The second end E2 is arranged on another end of the bracket 112 opposite to the first end E1. The shaft 112a is disposed adjacent to the first end E1. In the embodiment, the shaft 112a is disposed at a corner of the bracket 112. Moreover, the bracket 112 is rotatable about the shaft 112a, with the shaft 112a as a rotation center.

Referring to FIG. 8, in order to achieve a multi-directional tool changing function, the swing-type tool magazine system 100 further comprises a rotation device 30. The rotation device 30 is allowed to be equipped with a rotation motor. When the second end E2 of the bracket 112 is in contact with the limiting module 31, the rotation device 30 drives the second end E2 to rotate about the shaft 112a of the bracket 112, thereby rotating the tool 2 together with the bracket 112 to be aligned with the tool changing direction of the spindle 1a.

With the foregoing configuration, the present disclosure achieves following technical features.

The present disclosure features high efficiency. The tool storage device 10 simply needs to swing along the XY plane, thereby allowing the tool placement assembly 11 to be switchable between the tool storage area S and the tool changing area C for the spindle 1a to replace the tool 2, so as to enhance the efficiency of tool 2 replacement operation.

The present disclosure features large capacity and accommodate various tool specifications. The tool storage device 10 is capable of storing multiple sets of tools 2 simultaneously in a longitudinal or lateral direction, and the tool holder seats 113 are configured to accommodate tool holders and tools 2, and/or spindle heads or side heads of the same or different specifications as needed, thereby fulfilling the operational requirements of the machine tool 1.

The present disclosure features a space-saving function. Since the tool storage device 10 and the tool changing device 20 of the present disclosure directly perform the tool changing operation directly above the worktable 1b, thereby reducing the volume occupied in the machine tool 1.

The present disclosure features different working modes. The present disclosure provides storage of the tools 2 in a vertical orientation, a horizontal orientation, or a mixed arrangement of vertical and horizontal orientations, so as to accommodate different application scenarios. When arranged in the vertical orientation, the spindle 1a removes or returns the tools 2 more easily, and the structure is simpler. When arranged in the horizontal orientation, the spacing between the tool placement assemblies 11 can be arranged closer, thereby increasing the number of tool placement assemblies 11 and the number of tools 2 accommodated. Also, when the spindle 1a holds a side head or when the tool changing direction of the spindle 1a differs from that of the tool 2, the bracket 112 is rotatable, thereby achieving the multi-directional tool changing function.

The aforementioned objectives do not prevent the existence of other objectives. Those objectives derivable from the specification, claims, or drawings of the present disclosure by a person having ordinary skill in the field of the disclosure are also included in the scope of objectives of the present disclosure. Therefore, the objectives of the present disclosure are not limited to the aforementioned objectives.

Although particular embodiments of the disclosure have been described in detail for purposes of illustration, various modifications and enhancements may be made without departing from the scope of the disclosure. Accordingly, the disclosure is not to be limited except as by the appended claims.

What is claimed is:

1. A swing-type tool magazine system, disposed on a machine tool having at least a spindle, a tool storage area, and a tool changing area, the swing-type tool magazine system comprising:
a tool storage device disposed in the tool storage area, the tool storage device having at least a tool placement assembly and a reversing module, the tool placement assembly being swingably connected to the reversing module, the reversing module being configured to drive the tool placement assembly to swing along an XY plane, thereby switching the tool placement assembly between a first position in the tool storage area and a second position in the tool changing area; and
a tool changing device disposed in the tool changing area, wherein, when the tool placement assembly is at the second position, the tool changing device drives the tool placement assembly to move along an X-axis, switching the tool placement assembly between the second position and a tool changing position in the tool changing area, thereby allowing the spindle to remove or return a tool from or to the tool placement assembly.

2. The swing-type tool magazine system of claim 1, wherein the tool placement assembly comprises a reversing gear, a bracket, and a tool holder seat; a first end of the bracket is connected to the reversing gear; the tool holder seat is slidably disposed on the bracket; the reversing module comprises a first power unit and a driving gear; the driving gear is power-coupled to the first power unit, and the driving gear is movably engaged with the reversing gear, such that the bracket swings along the XY plane to switch between the first position and the second position.

3. The swing-type tool magazine system of claim 2, wherein the tool storage device comprises a plurality of tool placement assemblies stacked along a Z-axis; the plurality of tool placement assemblies are configured to be vertically movable along the Z-axis, and selectively position one of reversing gears at the first position, while other reversing gears are positioned at a standby position in the tool storage area; when one of reversing gears is positioned at the first position, the reversing gear at the first position engages with the driving gear, allowing the bracket at the first position to swing between the first position and the second position.

4. The swing-type tool magazine system of claim 3, wherein the tool storage device comprises a vertical movement module; the vertical movement module comprises a second power unit, a vertical movement seat, and a vertical movement rod; the vertical movement seat is connected to the second power unit; the vertical movement rod is disposed on the vertical movement seat along the Z-axis; the reversing gears of the tool placement assemblies are disposed on the vertical movement rod and spaced along the Z-axis.

5. The swing-type tool magazine system of claim 4, wherein each of the plurality of tool placement assemblies comprises a guide rail; the guide rails are connected to the tool holder seats, such that the tool holder seats are slidable on the brackets; the tool changing device comprises a pushing module and a lifting and lowering module; when one of the brackets is at the second position, the lifting and lowering module moves the pushing module downward into the tool changing area, and the pushing module pushes the tool holder seat at the second position, such that the guide rail slides on the bracket, whereby the tool holder seat switches between the second position and the tool changing position along the X-axis.

6. The swing-type tool magazine system of claim 5, wherein each of the tool holder seats comprises a first engagement portion, and the pushing module comprises a second engagement portion; when one of the tool holder seats moves to the tool changing area, the lifting and lowering module moves the pushing module downward to the tool changing area, such that the first engagement portion and the second engagement portion engage with each other to push the tool holder seat at the second position.

7. The swing-type tool magazine system of claim 6, wherein the tool holder seat is configured to accommodate tool holders, tools, spindle heads, or side heads of same or different specifications as needed.

8. The swing-type tool magazine system of claim 2, further comprising a rotation device, wherein the rotation device is disposed on a side of the tool changing area; the rotation device comprises a limiting module; when the bracket is at the second position, the bracket is in contact with the limiting module.

9. The swing-type tool magazine system of claim 8, wherein the bracket comprises a second end and a shaft; the second end is arranged on an end of the bracket opposite to the first end; the shaft is arranged adjacent to the first end, and the bracket is rotatable about the shaft.

10. The swing-type tool magazine system of claim 9, wherein when the second end of the bracket is in contact with the limiting module, the rotation device drives the second end of the bracket to rotate about the shaft, thereby rotating the tool together with the bracket to be aligned with a tool changing direction of the spindle.
